(19) United States
(12) Patent Application Publication
(10) Pub. No.: US 2002/0127308 A1
(43) Pub. Date: Sep. 12, 2002

(54) Conical sushi packages and wrappers therefor

(76) Inventors: Makoto Suzuki, Neyagawa-shi (JP); Eiichi Suzuki, Osaka-shi (JP)

Correspondence Address: Arnold B. Silverman, Eckert Seamans Cherin & Mellott, LLC, 44th Floor, 600 Grant Street, Pittsburgh, PA, 15219, US

(21) Appl. No.: 10/085,882

(22) Filed: Feb. 27, 2002

(30) Foreign Application Priority Data
Mar. 8, 2001 (JP) 2001-64175

(51) Int. Cl. A23B 4/00

(52) U.S. Cl. 426/115

(57) ABSTRACT

A conical sushi package comprises a conical mass of rice enclosed in a wrapper S. The wrapper S comprises an outer film, an inner film and a sheet of food sandwiched between these films, the films being heat-sealed at suitable portions so as to prevent the food sheet from slipping off. The outer film and the inner film comprise rectangular film pieces lapping over respective triangular film pieces at inner edges thereof. The laps are heat-sealed to prevent separation. The laps each have a discrete incision formed in the inner film piece in contact with the feed sheet along the lap and covered with an end portion of lap of the outer film piece. The wrapper S is provided around the conical surface of the mass of rice and has a triangular end thereof positioned at the tapered end of the rice.

### FIELD OF THE INVENTION

The present invention relates to conical sushi packages each comprising a wrapped conical mass of rice and wrappers for such packages.

### BACKGROUND OF THE INVENTION

The present applicant has previously proposed a conical sushi package comprising a small conical mass of rice 4 enclosed as shown in FIG. 16 in a wrapper shown in FIGS. 13 and 14 (Japanese Patent No. 2,990,196).

The wrapper S for the conical sushi package is prepared by sandwiching a sheet of food 3 such as seaweed between an outer film 100 and an inner film 200 as shown in FIGS. 14 and 15, and joining the outer film 100 and the inner film 200 by heat sealing as at 140 along their outer peripheries as seen in FIG. 13. The outer film 100 and the inner film 200 are formed respectively from rectangular film pieces 110, 210 and triangular film pieces 120, 220 each generally in the form of an isosceles triangle, each by lapping the long sides of the two pieces over each other. The lap 150 of the two film pieces 110, 120 of the outer film 100 is weakly heat-sealed as at 130 in the form of dots and can easily be separated.

The conical sushi package shown in FIG. 16 is prepared by fitting the wrapper S around the conical surface of the conical mass of rice 4, with the inner film 200 in contact with the rice 4 and with the tapered portion of the rice 4 corresponding to the triangular end portion of the wrapper S. Opposite ends of the wrapper S are joined together with a seal piece 5.

To open the sushi package, the upper end of the sushi package as positioned with its tapered end down as shown in FIG. 16 is held by one hand, the lower end of the package is held by the other hand, and the upper edge of the wrapper S is pulled up.

The upper rectangular film piece 210 of the inner film 200 merely overlaps the lower triangular film piece 220 thereof, while the upper rectangular film piece 110 of the outer film 100 is joined to the lower triangular film piece 120 thereof by heat sealing as at 130. Accordingly, if the wrapper S is pulled upward at its upper edge with the lower end of the conical mass of rice 4 grasped, the rectangular film pieces 110, 210 of the outer film 100 and the inner film 200 are pulled up as separated from the respective triangular film pieces 120, 220. The rectangular film pieces 110, 210 slip relative to the food sheet 3 at this time, so that the food sheet 3 is unlikely to move upward but becomes exposed while partly fitting around the conical mass of rice 4.

Next, the exposed upper end portion of the conical sushi package, having its rectangular film pieces 110, 210 removed, is grasped by one hand, and the lower end of the wrapper covering the conical mass of rice 4 is grasped by the other hand and pulled down, whereby the triangular film pieces 120, 220 only are drawn downward as seen in FIG. 17B. The sheet of food 3 remains, directly covering the conical mass of rice 4.

The portion of the wrapper covering the tapered portion of the conical mass of rice 4 is triangular and fitted around the rice over a reduced area, so that the rice offers small resistance when the films are pulled out, permitting the films to be pulled out smoothly.

However, the applicant has found that the wrapper still remains to be improved with respect to the following.

The outer film 100 and the inner film 200 are strongly heat-sealed as at 140 along their outer edges so as not to separate from each other as shown in FIG. 13, whereas the laps 150, 250 of the rectangular film pieces 110, 210 and the triangular film pieces 120, 220 are not so heat-sealed because if the heat seal 140 is provided also at the laps 150, 250, the inner and outer films 100, 200 fail to separate into the rectangular film pieces 110, 120 and the triangular film pieces 120, 220.

However, the rectangular film piece and the triangular film piece of at least one of the outer film 100 and the inner film 200 need to be joined together separably. If otherwise, the rectangular film pieces 110, 210 initially separate from the triangular film pieces 120, 220, and the conical mass of rice 4 can not be enclosed in the wrapper S.

For this reason, the rectangular piece 110 and the triangular piece 120 of the outer film 100 providing an exposed covering of the package are heat-sealed as at 130 so as to be readily separable.

The strength of the heat seal is nevertheless difficult to adjust finely; if the seal is excessively strong, the film 100 will not separate, while too weak a seal permits separation of the two pieces before wrapping. The wrapper then fails to provide a commodity in either case.

The strength of the heat seal varies with delicate variations in the voltage to be supplied to the heat-sealing heater, variations in the room temperature of the plant and variations in the ambient conditions for the storage of the film. Difficulties are therefore encountered in providing heat seals of delicate strength by controlling the heat sealing conditions as specified.

The conical mass of rice 4 packaged with the wrapper is left open at its flaring end, and is therefore likely to be exposed directly to dust or to be brought into direct contact with fingers, hence a sanitation problem.

Additionally there is a likelihood that extraneous matter will be incorporated into the packaged sushi intentionally through the open end substantially without leaving traces of such an attempt.

The present invention provides a conical sushi package and a wrapper therefor which are free of the above problem.

### SUMMARY OF THE INVENTION

The present invention provides a wrapper S which comprises an outer film 1, an inner film 2 and a sheet of food 3 sandwiched between the films 1, 2, the films 1, 2 being heat-sealed at suitable portions of outer peripheries thereof so as to prevent the sheet of food 3 from slipping off. The wrapper S is fitted around the conical surface of a conical mass of rice 4 with the inner film 2 positioned inside.

The outer film 1 and the inner film 2 comprise generally isosceles triangular film pieces 12, 22 lapping over respective generally rectangular film pieces 11, 21 at long side edges thereof and are each in a generally pentagonal form.

The outer film 1 has a lap 15 provided by the rectangular film piece 11 and the triangular film piece 12 and joined by heat sealed as at 16 to prevent separation. The lap 15 has a discrete incision 17 formed in one of the film pieces and covered with an end portion 15a of the other film piece from inside or outside thereof.

Like the outer film 1, the inner film 2 also has a lap 25 provided by the rectangular film piece 21 and the triangular film piece 22 and heat-sealed to prevent separation. One of the film pieces may have a discrete incision 27 formed in the lap 25 and covered with an end portion 25a of the other film piece from inside or outside thereof.

The present invention provides a conical sushi package comprising a conical mass of rice 4 and the wrapper S provided around the conical surface of the rice 4 with the triangular portion of the inner film 2 of the wrapper S positioned around the tapered end of the rice 4.

At least one of the outer film 1 and the inner film 2 may have a covering portion 10 extending from a long side of the rectangular film thereof beyond a heat seal 18 for covering a flaring end of the conical mass of rice 4 (see FIG. 9).

With the conical sushi package, the sheet of food 3 is sandwiched between the outer film land the inner film 2, therefore protected from the atmospheric air or moisture of the rice and prevented from becoming impaired in taste and flavor. The incision 17 formed in one of the film pieces of the outer film 1 for separating this film 1 is covered with the end portion 15a of the other film piece thereof from inside or outside. This prevents the atmospheric air from ingressing into the wrapper through the incision 17 to moisten the sheet of food 3.

To unwrap the sushi package, the lower end of the package as positioned with its tapered end down is held by one hand, and the upper edge of the wrapper S is pulled up by the other hand.

Since the outer film 1 is firmly heat-sealed at the lap 15 of the upper rectangular film piece 11 and the lower triangular film piece 12 against separation, the outer film 1 is unlikely to separate at the heat seal 16.

However, aside from the heat seal 16, the lap 15 has the incision 17 formed in one of the film pieces, so that the outer film 1 separates into two pieces along the incision 17.

The lap 25 of the rectangular film piece 21 and triangular film piece 22 of the inner film 2 is a mere overlapping portion, or is made separable like that of the outer film 1. Accordingly, an upward pull exerted on the upper edge of the wrapper S separates the rectangular film pieces 11, 21 of the outer and inner films 1, 2 from the triangular film pieces 12, 22 along the incision 17 (and the incision 27), drawing up these pieces 11, 22. At this time, the rectangular film pieces 11, 21 slip relative to the sheet of food 3, which is therefore unlikely to move upward.

When the lower end of the wrapper covering the conical sushi 4 is then grasped and pulled down, only the triangular film pieces 12, 22 are drawn out, permitting the sheet of food 3 to remain to cover the sushi 4 directly.

Even in the case where the lap 25 of the inner film 2 is provided with the heat seal 26 and has the discrete incision 27 formed in one of the film pieces thereof as in the outer film 1, the moisture of the rice can be prevented from ingressing into the wrapper through the incision 27 and moistening the sheet of food 3 for the same reason as is the case with the outer film 1.

With the wrapper of the present invention, the laps 15, 25 of the outer film 1 and the inner film 2 can be heat-sealed with high strength against separation. Accordingly, the heat sealing conditions need not be strictly controlled as in the prior art so as not to permit the separation of the laps 15, 25.

Since the tapered portion of the conical sushi is covered with the generally triangular portion of the wrapper, the wrapper laps over itself over a reduced area when enclosing the sushi. This results in diminished resistance against the film pieces to be pulled out, permitting the film pieces to be pulled out smoothly and obviating the likelihood that the conical mass of rice will have its tapered end broken off or will be collapsed due to excessive resistance offered to the film pieces to be pulled out.

When the rectangular film piece of at least one of the outer and inner films 1, 2 is provided with a cover portion 10 to close the flaring end of the conical mass of rice 4 with the cover portion 10, this portion 10 serves to prevent the rice 4 from drying and becoming impaired in flavor and taste. The cover portion further eliminates the likelihood that the rice 4 will be exposed directly to dust or brought into contact with fingers to ensure sanitation and prevent ingress of extraneous matter.

### BRIEF DESCRIPTION OF THE DRAWINGS

FIG. 1 is a perspective view of a wrapper, with an end portion of a rectangular film piece turned over;

FIG. 2A is a perspective view of an outer film before a rectangular film piece is joined to a triangular film piece by heat sealing, FIG. 2B is a perspective view of the outer film with the two film pieces joined together;

FIG. 3 is an exploded perspective view of a wrapper;

FIG. 4 is a view of the wrapper in section taken along a plane containing the line A-A in FIG. 1;

FIG. 5 is a perspective view the wrapper as rolled into a conical shape;

FIG. 6 is a sectional view of the wrapper as rolled into the conical shape and rice as placed therein;

FIG. 7 is a sectional view of the same with the rice pressed in;

FIG. 8 is a perspective view of a conical sushi package;

FIG. 9 is a perspective view of another embodiment of wrapper having a cover portion as an extension;

FIG. 10 is a sectional view of the wrapper of FIG. 9 as rolled into a conical shape and having rice pressed in;

FIG. 11 is a sectional view of the same with the cover portion heat-sealed as clamped on opposite sides thereon;

FIG. 12 is a perspective view showing the cover portion as closed completely;

FIG. 13 is a perspective view of a wrapper previously proposed by the applicant;

FIG. 14 is a view of the wrapper in section taken along a plane containing the line A-A in FIG. 13;

FIG. 15 is an exploded perspective view of the wrapper of FIG. 13;

FIG. 16 is a perspective view of a conical sushi package prepared with use of the wrapper of FIG. 13; and

FIGS. 17A and 17B are diagrams showing a procedure for unwrapping the sushi package of FIG. 16.

### DESCRIPTION OF THE PREFERRED EMBODIMENTS

(Construction of Wrapper)

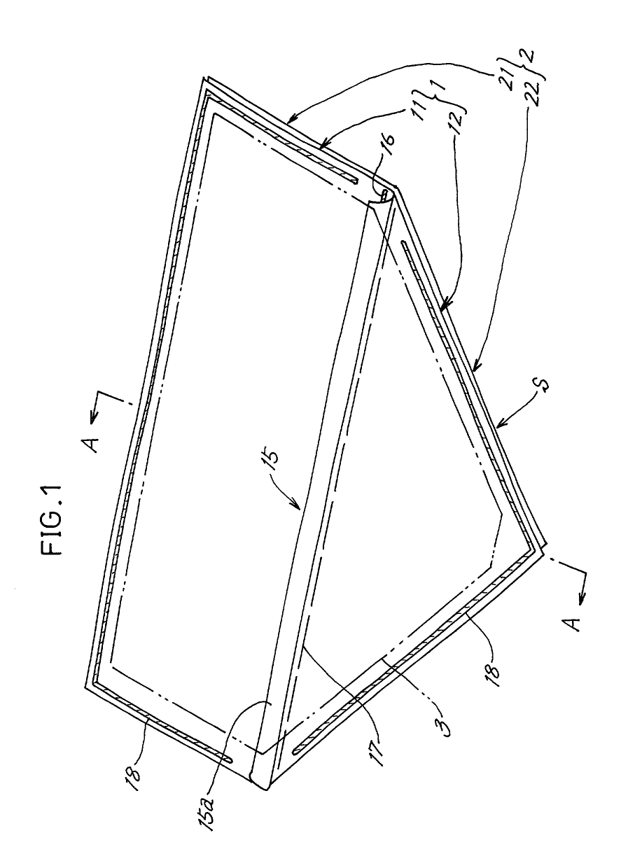

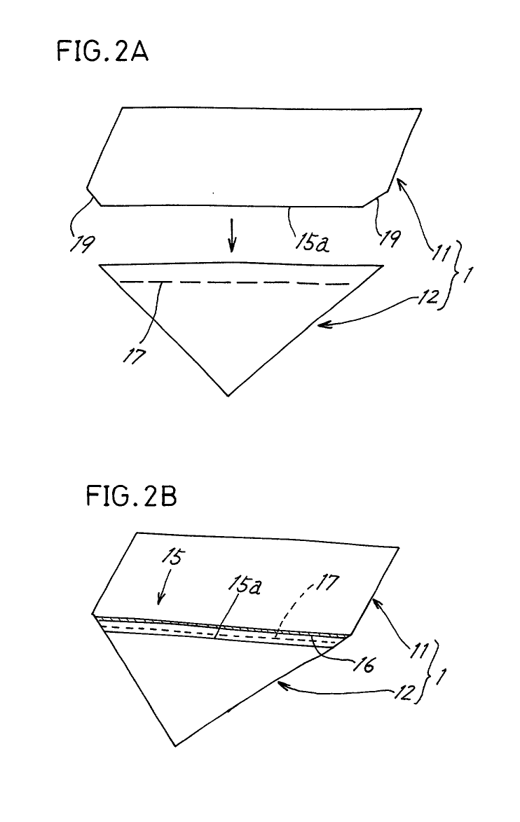

FIG. 1 is a perspective view of a wrapper S, with an end portion of a rectangular film piece 11 to be described below turned over. The wrapper S comprises an outer film 1, an inner film 2 and a sheet of food 3 sandwiched between these films. The films 1, 2 are heat-sealed along their peripheries.

The outer film 1 is made from a transparent resin film. The inner film 2 is made from a resin film which exhibits high slipping properties on rice.

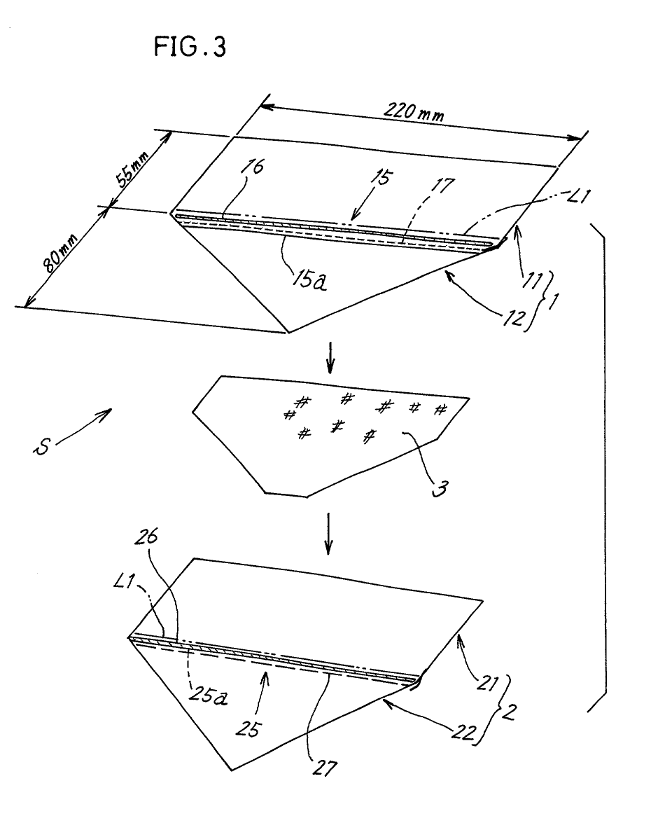

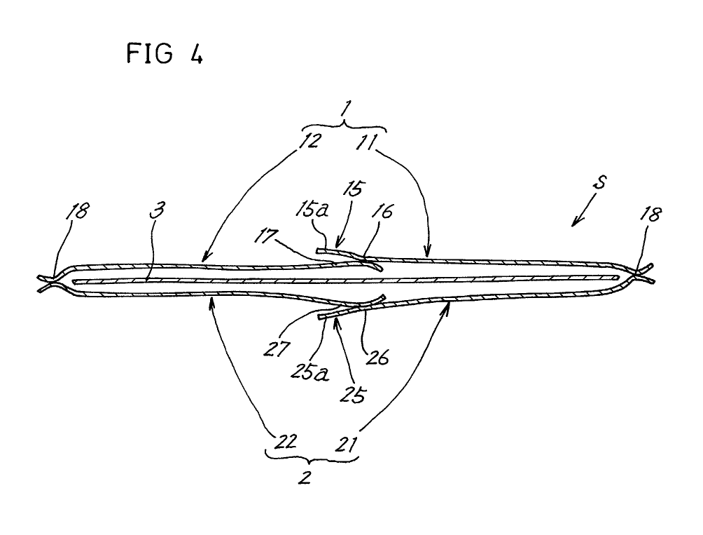

As shown in FIGS. 3 and 4, each of the outer film 1 and the inner film 2 is formed by lapping the long side of an isosceles triangular film piece 12 (22) over one of the long sides of a rectangular film 11 (21), and joining the lap by heat sealing. The film 1 (2) is generally pentagonal in its entirety.

The rectangular film piece 11 (21) is cut as at 19 at opposite sides of the side where the triangular film piece 12 (22) is lapped over, in conformity with the oblique sides of the triangular film piece 12 (22). The cut portions 19 may have a desired size, i.e., may be large or small. The triangular film pieces 12, 22 are each generally in the form of an isosceles triangle.

With reference to FIG. 3, the rectangular film pieces 11, 21 of the illustrated embodiment are about 220 mm in length and about 55 mm in width, and the height of projection of each of the triangular film pieces 12, 22 is about mm. The rectangular film piece 11 (21) and the triangular film piece 12 (22) have a lap 15 (25) with a width of about 10 mm.

As shown in FIG. 4, in the outer film 1 (inner film 2), the triangular film piece 12 (22) is positioned adjacent to the sheet of food 3, i.e., on the inner side of the lap 15 (25). At the lap 15 (25), the rectangular film piece 11 (21) is joined to the triangular film piece 12 (22) by heat sealing so as not to separate therefrom.

According to the present embodiment, a heat seal 16 (26) is provided in the form of a line extending over the entire length of the lap 15 (25).

With reference to FIG. 4, a discrete incision 17 (27) is formed in the triangular film piece 12 (22) over the entire length of the piece 12 (22) along the heat seal 16 (26) in the vicinity thereof. The incision 17 (27) extends through the entire thickness of the film piece 12 (22).

The rectangular film piece 11 (21) has an end portion 15a (25a) covering the discrete incision 17 (27) from outside.

With reference to FIG. 3, a boundary between the rectangular film piece 11 (21) and the triangular film piece 12 (22) is indicated at L1. According to the present embodiment, the lap 15 (25) and the incision 17 (27) of the outer film 1 (inner film 2) are positioned in the vicinity of the boundary L1 between the rectangular film piece 11 (12) and the triangular film piece (12 (22) as shown in FIG. 3. The boundary L1 may be positioned as translated toward the projecting end of the triangular film piece. This shift is up to ⅓ of the height of projection of the triangular film piece 12 (22). If the lap 15 (25) is greatly shifted toward the projecting end of the triangular film piece 12 (22), the resistance to be offered to the pull on the rectangular film piece 11 (21) for unwrapping the package becomes excessive to collapse the conical mass of rice 4.

The sheet of food 3 of the embodiment is a sheet of seaweed which is cut to a smaller size than the inner and outer films 2, 1. However, the feed sheet 3 is not limited to the sheet of seaweed but can be an edible sheet of food such as a sheet of kombu (kelp) or the like.

The wrapper S is completed by sandwiching the sheet of feed 3 between the outer film 1 and the inner film 2, and heat-sealing the films 1, 2 along the outer peripheries thereof in the form of a line or dots or spots without crossing the laps 15, 25 of the rectangular film pieces 11, 21 and triangular film pieces 12, 22. The heat seal need not be separated and can therefore be formed strongly to avoid separation.

(Procedure for Packaging Conical Sushi)

The wrapper is used for preparing a conical sushi package by the procedure to be described below.

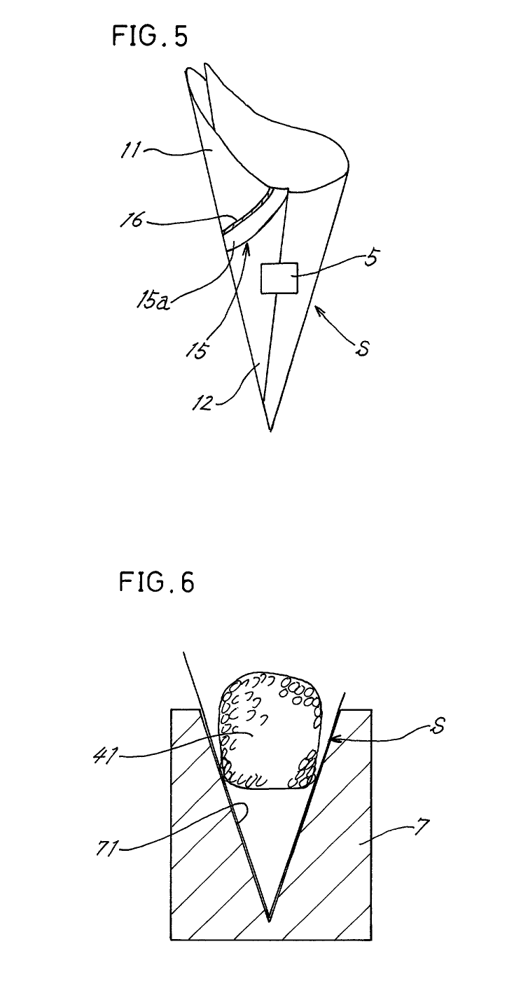

First, the wrapper S is rolled into a conical shape, with the triangular film pieces 12, 22 forming a tapered portion as seen in FIG. 5, and the rolled end is fastened with a seal piece 5.

Next, the conical wrapper S is fitted into a conical bore 71 formed in a guide block 7 as shown in FIG. 6. A mass of rice 41 is then placed into the wrapper S from above the wrapper S.

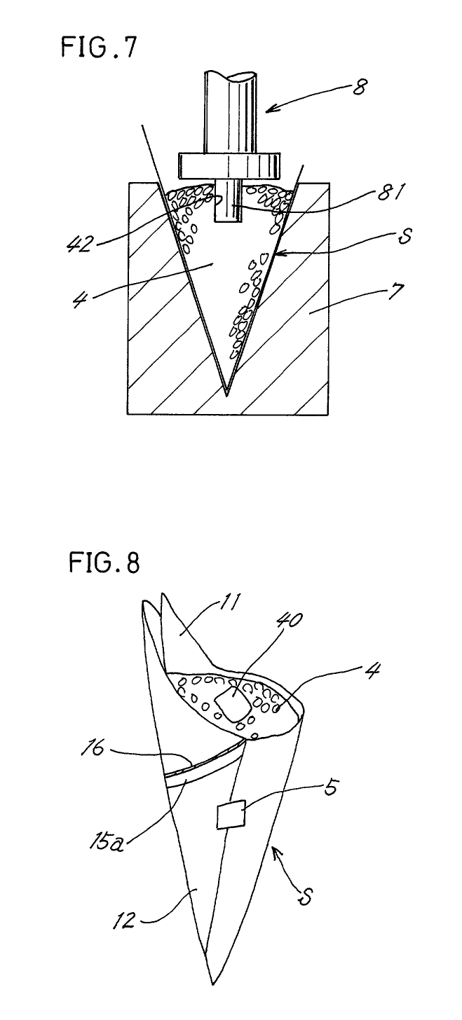

The mass of rice 41 is pressed into the wrapper S to the tapered end of the cone by a plunger member 8 from above the guide block 7 to fill the wrapper with the rice 41 as shown in FIG. 7. The rice is molded into a conical shape, and a bore 42 is formed in the top of the conical mass of rice 4 with a boring piece 81 of the plunger member B.

Topping 40 shown in FIG. 8 is placed into the bore 42, and the resulting mass is removed from the guide block 7 to complete a conical sushi package. The topping 40 is a food and can be any food insofar as it is to be eaten with the conical mass of rice 4.

With the sushi package of the invention, the rectangular film piece 11 of the outer film 1 is positioned above the upper end of the conical mass of rice 4, with the conical portion of the mass of rice 4 directed downward. The sheet of food 3 is sandwiched between the outer film land the inner film 2, protected from the atmospheric air and the moisture of the rice and prevented from becoming impaired in flavor and taste.

With reference to FIG. 4, the discrete incision 17 for separating the outer film 1 is covered with the end portion 15a of the rectangular film piece 11. For this reason, the atmospheric air is unlikely to ingress into the wrapper S to moisten the food sheet 3. The discrete incision 27 of the inner film 2 is also covered with the end portion 25a of the rectangular film piece 21, whereby the moisture of the rice is also prevented from ingressing into the wrapper through the incision 27 to moisten the food 3.

(Procedure for Unwrapping the Conical Sushi Package)

To unwrap the sushi package, the lower end portion of the package is grasped by one hand, and the upper edge of the wrapper S shown in FIG. 5 is pulled up by the other hand.

Since the laps 15, 25 of the outer and inner films 1, 2 provided by the rectangular film pieces 11, 21 and the triangular film pieces 12, 22 are heat-sealed against separation, there is no likelihood that the outer and inner films 1, 2 will separate at the heat seals 16, 26.

However, with the incisions 17, 27 formed in the outer and inner films 1, 2 in the vicinity of heat seals 16, 26 within the regions of the laps 15, 25, each of the films 1, 2 is separated into two portions along the incision 17 or 27.

The incision 17 (27) is positioned in the vicinity of the boundary L1 between the rectangular film piece 11 (21) and the triangular film piece 12 (22), i.e., in the film 1 (2) on the flaring side of the conical mass of rice 4. This reduces the distance of pull for drawing up the rectangular film piece 11 (21) to diminish the resistance to the pull, consequently serving to preclude the conical mass of rice 4 from collapsing.

After the rectangular film pieces 11, 21 are removed, the exposed upper end portion of the sushi package is grasped by one hand, and the triangular film pieces 12, 22 around the lower end portion are pulled by the other hand, whereby these film pieces 12, 22 only are drawn downward. The sheet of food 3 remains, directly covering the conical mass of rice 4.

(Another Embodiment of Wrapper)

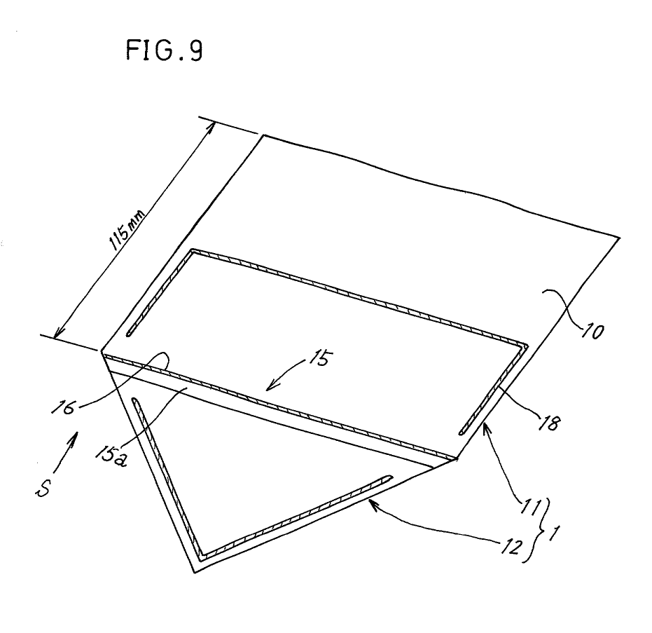

FIG. 9 shows another embodiment of wrapper S. A rectangular cover portion 10 extends from a long side of a rectangular film piece 11 of an outer film 1 integrally therewith. The cover portion 10 has a width of about 60 mm and extends over the entire length of the long side of the film piece 11.

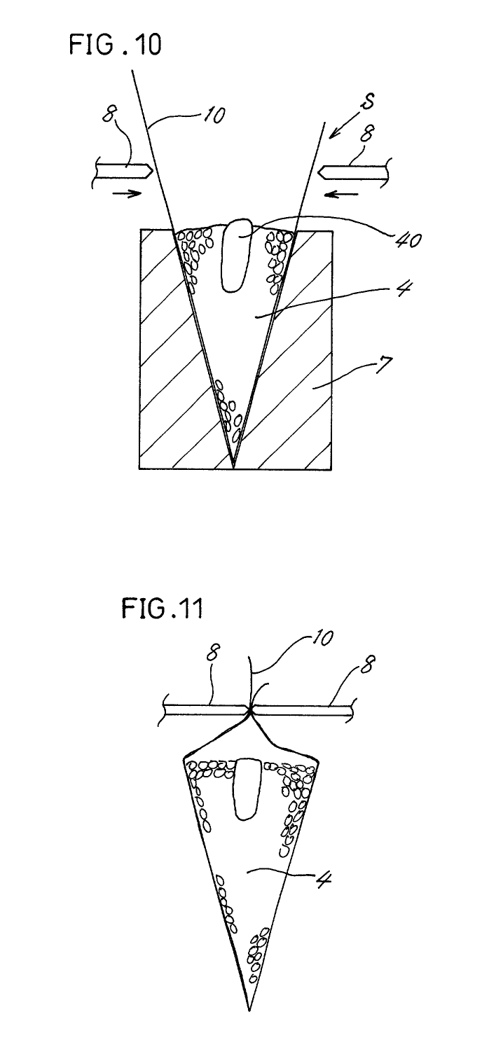

FIG. 10 is a sectional view showing the wrapper S of FIG. 9 as rolled into a conical shape and fitted into a guide block 7, with rice pressed into the wrapper. When the rice is filled into the wrapper S as rolled in the conical form by the procedure described above, the cover portion 10 projects upward greatly beyond the top of the conical mass of rice 4.

After the rice has been placed into the rolled wrapper S, two heat-sealing butting members 8, 8 are arranged as opposed to each other externally of the wrapper S. The cover portion 10 is heat-sealed in spots by moving the two butting members 8, 8 toward each other (see FIGS. 10 and 11).

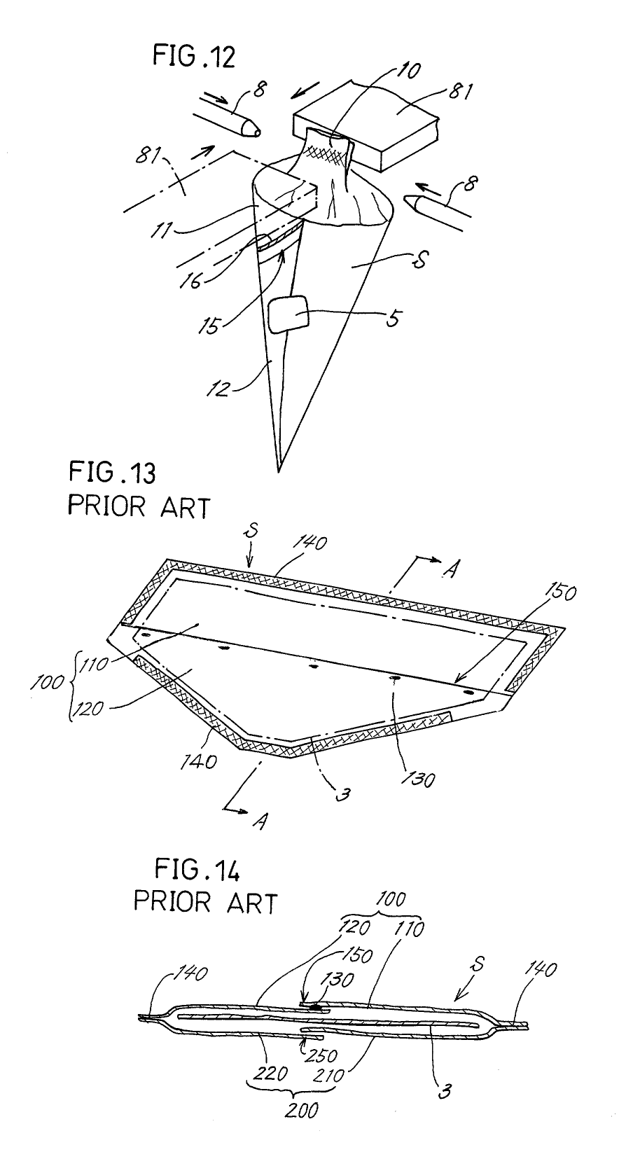

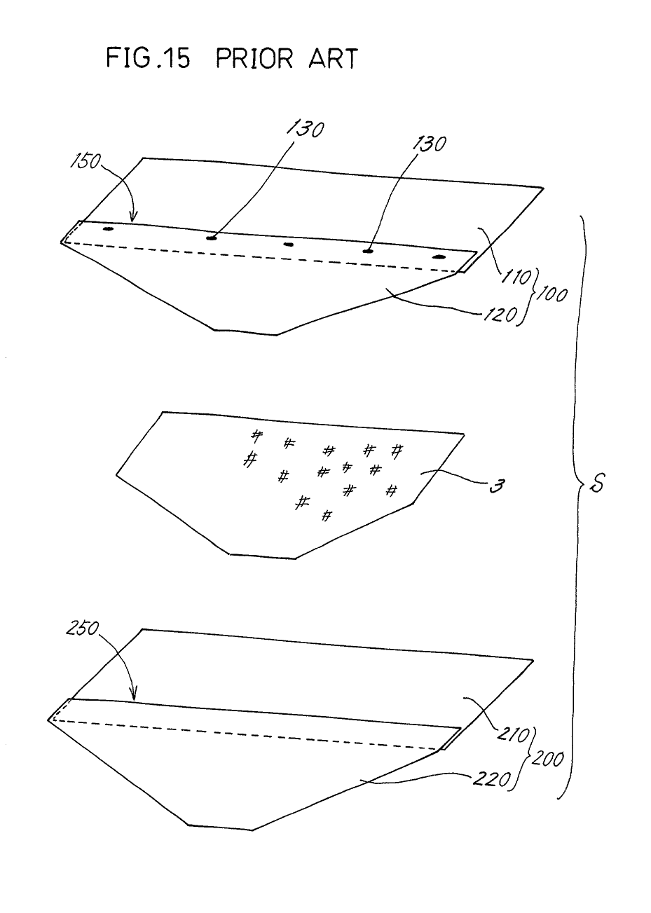

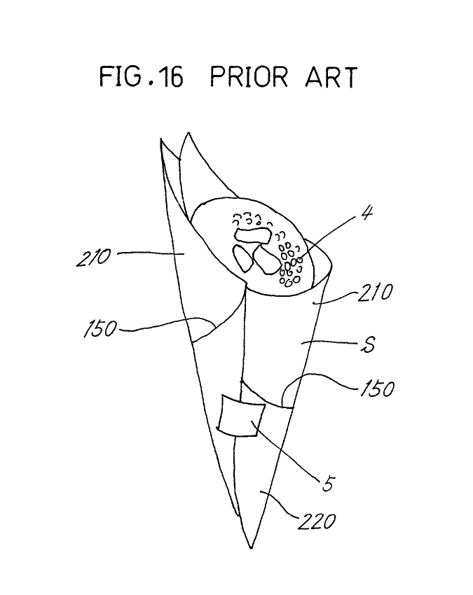

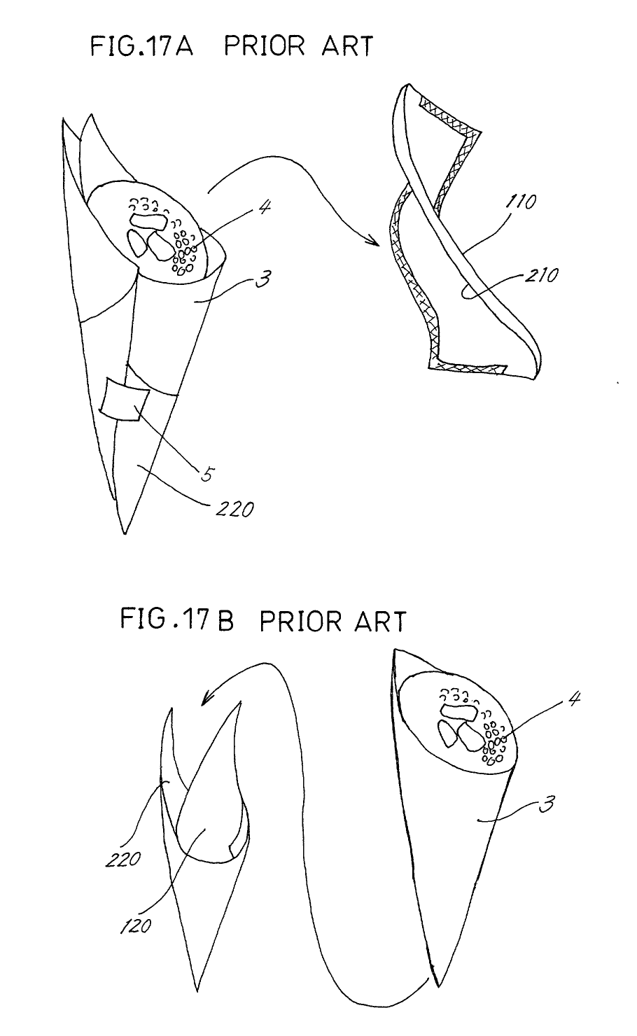

Next as shown in FIG. 12, the cover portion 10 is closed by heat sealing with heat-sealing champs 81, 81 which are movable toward or away from each other in a direction orthogonal to the butting members 8, 8.

The end face of the conical mass of rice 4 is also covered with the film by this procedure to ensure sanitation and obviate ingress of extraneous matter. Even if an attempt is made to incorporate extraneous matter into the rice intentionally, the package then needs to be opened at least partially. This leaves traces of the attempt, hence safety.

Since the cover portion 10 is formed as an extension of the transparent outer film 1, this embodiment has the advantage that the conical mass of rice 4 and topping 40 can be seen through the cover portion 10 from outside even if the cover portion 10 is closed. A cover portion 10 may be provided by extending the inner film 2 only, or cover portions 10 may alternatively be formed by extending both the outer and inner films 1, 2.

Further according to the embodiment described, the triangular film pieces 12, 22 are positioned on the inner side of the laps 15, 25 of the outer and inner films 1, 2 and are in contact with the sheet of food 3, with the rectangular film pieces 11, 21 positioned on the outer side thereof. The incision 17 of the outer film 1 is therefore concealed by the end portion 15a of the rectangular film piece 11 to render the package sightly in appearance. The end portion 25a of the rectangular film piece 21 over the incision 27 in the triangular film piece 22 of the inner film 2 extends downward (see FIG. 4) when the mass of rice 41 is placed into the wrapper as rolled into a conical shape as shown in FIG. 6, so that the mass of rice 41 to be placed in will not become caught by the end portion 25a.

However, if the rectangular film pieces 11, 21 are positioned on the inner side of the laps 15, 25 of the outer and inner films 1, 2, in contact with the sheet of food 3, with the triangular film pieces 12, 22 positioned on the outer side thereof, and the end portions 15a, 25a of the rectangular film pieces 11, 21 are positioned to cover the incisions 17, 27 from the food sheet side (from inside), moisture can also be prevented from ingressing into the wrapper through the incisions 17, 27.

The incisions 17, 27 of the inner and outer films 1, 2 need not always be formed in the triangular film pieces 12, 22 as described above. For example, the laps 15, 25 can be provided with discrete incisions formed in the respective rectangular film pieces 11, 21 for the end portions of the triangular film pieces 12, 22 to cover the respective incisions from outside or inside.

In the case where an unwrapping incision is formed in an outer film which is in the form of a single film, the outer film can be separated into two portions, whereas this wrapper has the problem of permitting the ingress of atmospheric air to moisten the sheet of food 3.

Although the incisions 27, 17 are formed respectively in the inner film 2 and the outer film 1 according to the embodiment described, the incision 27 may be formed only in the outer film 2. In this case, the rectangular film piece 21 and the triangular film piece 22 may merely lap over each other at the lap 25 of the inner film 2.

The outer film 1 and the inner film 2 are provided with the respective incisions 17, 27, whereas a line of reduced thickness or weak adhesion readily permitting separation may be used instead of the incision.

What is claimed is:

1. A conical sushi package comprising a conical mass of rice and a wrapper S having the mass of rice enclosed therein and comprising an outer film, an inner film and a sheet of food sandwiched between the films, the two films being heat-sealed at suitable portions of outer peripheries thereof so as to prevent the sheet of food from slipping off, the wrapper having its inner film positioned inside and fitted around a conical surface of the mass of rice,
the outer film and the inner film comprising generally isosceles triangular film pieces lapping over respective generally rectangular film pieces at long side edges thereof to form each of the films in a generally pentagonal shape,
the outer film having a lap provided by the rectangular film piece and the triangular film piece and joined by heat sealing to prevent separation,
the lap having a separable portion formed in one of the film pieces within the region of the lap, the separable portion being covered with an end portion of the other film piece from inside or outside thereof,
the wrapper S being provided around the conical surface of the mass of rice and having a triangular end thereof positioned at a tapered end of the rice.

2. A conical sushi package according to claim 1 wherein the separable portion is provided by a discrete incision, a line of reduced thickness or weak adhesion, and at least one of the outer film and the inner film has a cover portion formed on one side of the film opposite to the other side thereof where the triangular film piece extends.

3. A conical sushi package according to claim 1 wherein the inner film has a lap provided by the rectangular film piece and the triangular film piece and joined by heat sealing to prevent separation, and the lap is provided with a discrete incision formed in one of the film pieces thereof along the lap, the incision being covered with an end portion of the other film piece.

4. A conical sushi package according to claim 1 wherein heat seals of the laps of the outer film and the inner film are each provided in the form of a line extending over the entire length of the lap.

5. A conical sushi package according to claim 1 wherein at the laps of the outer film and the inner film, the triangular film pieces are positioned on the inner side of the lap in contact with the sheet of food and the rectangular film pieces are positioned on the outer side thereof, incisions being formed in the respective triangular film pieces.

6. A wrapper comprising an outer film, an inner film and a sheet of food sandwiched between the films, the two films being heat-sealed at suitable portions of outer peripheries thereof so as to prevent the sheet of food from slipping off, the wrapper being adapted to enclose a mass of rice therein with its inner film positioned inside to fit around a conical surface of the mass of rice,
the outer film and the inner film comprising generally isosceles triangular film pieces lapping over respective generally rectangular film pieces at long side edges thereof to form each of the films in a generally pentagonal shape, the outer film having a lap provided by the rectangular film piece and the triangular film piece and joined by heat sealing to prevent separation, the lap having a separable portion formed in one of the film pieces within the region of the lap, the separable portion being covered with an end portion of the other film piece from inside or outside thereof.

7. A wrapper according to claim 6 wherein the separable portion is provided by a discrete incision, a line of reduced thickness or weak adhesion, and the inner film has a lap provided by the rectangular film piece and the triangular film piece and joined by heat sealing to prevent separation, the lap having a discrete incision formed in one of the film pieces thereof along the lap, the incision being covered with an end portion of the other film piece.

8. A wrapper according to claim 6 wherein heat seals of the laps of the outer film and the inner film are each provided in the form of a line extending over the entire length of the lap.

9. A wrapper according to claim 6 wherein at the laps of the outer film and the inner film, the triangular film pieces are positioned on the inner side of the lap in contact with the sheet of food and the rectangular film pieces are positioned on the outer side thereof, incisions being formed in the respective triangular film pieces.
